(19) United States
(12) Patent Application Publication
(10) Pub. No.: US 2007/0084059 A1
(43) Pub. Date: Apr. 19, 2007

(54) Oscillating triple head electric shaver

(76) Inventors: Jeremiah (Jerry) M. Hannan, San Rafael, CA (US); Thomas P. Hannan, San Rafael, CA (US)

Correspondence Address: JERRY HANNAN, 248 McNEAR DRIVE, SAN RAFAEL, CA, 94901, US

(21) Appl. No.: 11/250,746

(22) Filed: Oct. 17, 2005

(51) Int. Cl. B26B 19/14

(52) U.S. Cl. 30/43.5

(57) ABSTRACT

The present invention arose as a result of the absence in prior art of a means of producing an oscillating motion of the cutter foils in an electric shaver with rotary cutting heads that are in planetary motion. In current practice the cutter foils are stationary when the cutters are rotating. In the present invention the cutter foils can be engaged to oscillate when the cutters are rotating and can be disengaged to use the shaver in the conventional manner.

The subject of this patent application is an improved triple-head electric shaver. The oscillating electric shaver is made up of the following parts, namely, a drive motor, gears made of hard plastic or other suitable material to drive the shafts that connect to, and rotate the cutters, an additional drive shaft of hard plastic or other suitable material mounted in the center between the three drive shafts that rotate the cutters. A large gear on this center drive shaft connected to smaller gears on the three drive shafts. A bearing with connecting arms to the foils, made of metal, hard plastic or nylon, located in the shaver head and is connected to the three foils of the cutters. A cam of suitable hard wearing material on the end of the center drive shaft that engages the bearing. A lever mounted in the shaver head or body to disengage the cam from the bearing. A spring in the center drive shaft to engage the cam to the bearing. Splines on the center drive shaft that mate with splines or grooves in its sleeve.

A modified retainer to hold the foils and cutters in place in the shaver head. All the parts used in this invention are constructed of suitable hard wearing materials with the exception that the foils, and or the bearing surfaces on the shaver head that the foils make contact with, may use, or be coated with teflon to reduce friction between the oscillating foils and the shaver head. The present invention relates to improvements in a triple head electric shaver and it consists in the combination, construction and arrangements of parts as hereinafter described and claimed.

The object of the invention is to provide a conventional electric shaver and add a center drive shaft to it to make the foils oscillate in the shaver head. This is accomplished by preferably connecting the foils to a small bearing installed in the shaver head. A cam, preferably offset in the rotating center shaft causes the bearing together with the attached foils to oscillate in the shaver head. The links from the bearing to the foils are attached solidly to the bearing and hinged to the foils thus allowing the foils to oscillate with ease in the shaver head. The rate of oscillation in relation to the rotation of the cutters is preferably 2.2 to 1.

This is accomplished by the large reduction gear on the center drive shaft and the smaller gears preferably mounted on the cutter drive shafts. Alternatively, grooved pulleys on the cutter drive shafts and a large grooved pulley on the center drive shaft together with one or more driving belts can be used instead of gears to rotate the center drive shaft.

It is possible if so desired, to further reduce the motion of the foils relative to the rotation speed of the cutters preferably with the use of additional gearing or drive belts and pulleys.

The operator can disengage the oscillation by means of a lever mounted in the shaver head or body. To engage the oscillating feature he merely moves the lever back to the original position allowing the spring to offer the cam back into the bearing. The rotating center shaft is preferably held on center on one end by the extended shaft from the drive motor and preferably by a steady pin at its other end in the center of the shaver head. The operator therefore has the choice of using his shaver in the conventional fashion or engaging the oscillating feature for a faster and smoother shave.

To a better understanding of my invention, reference should be made to the accompanying drawing, forming part of this specification, in which:

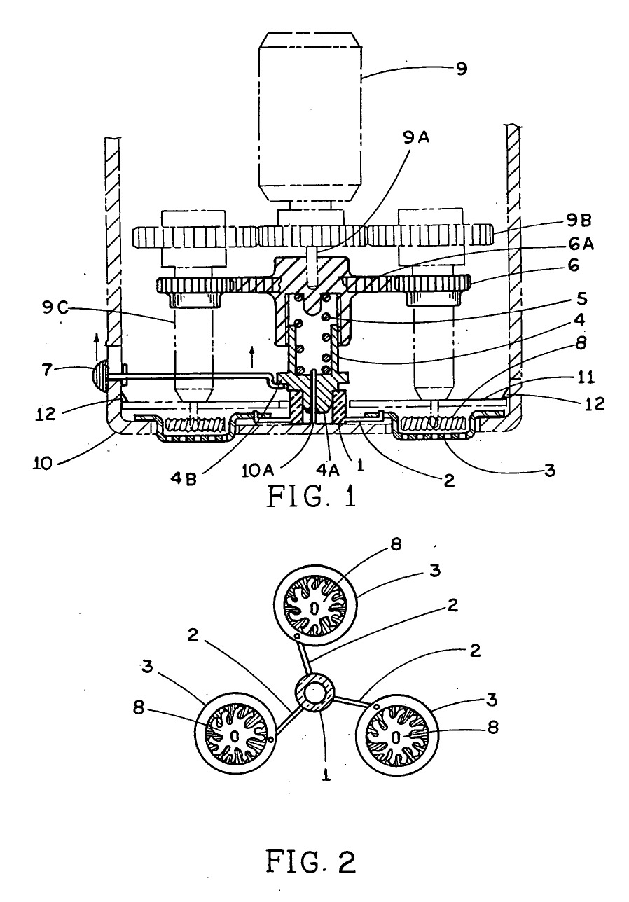

FIG. 1 is a vertical section through an electric shaver and shows my center drive shaft (4) operatively applied thereto. The cam (4A), is shown engaged in the bearing (1) which is attached to the foils (3) by means of links (2). (10A) is the steady pin in the center of the shaver head that holds drive shaft (4) rotating on its center line. The cam (4A) is tapered for easy entry to the bearing and is countersunk at its entry point for easy engagement over the steady pin (10A)

FIG. 2 is an expanded view of the bearing (1) together with the attaching links (2) and the foils (3) together with the cutters (8). In actual practice these parts are quite small and are assembled close together.

### DETAILED DESCRIPTION

In carrying out our invention I will describe the construction and operation of our improved Triple Head Electric Shaver. The electric motor (9) supplies the power, the motor is provided with a gear that connects to a gear assembly (9B) to which are attached three drive shafts (9C), (of which only two are shown in the drawing). Each of the three drive shafts are equipped with small gears (6) that connect to a large center gear and hub (6A) to which is attached the center drive shaft (4). The center shaft (4) has splines on its outer surface that mate with inner splines in its hub. The center shaft (4) has the ability to slide up and down in its hub and remain in lock step to the rotating hub. The center shaft (4) is provided with an inner spring (5) that exerts a force downward against the base of the gear hub assembly (6A) and upward against the cam end (4A) of the center drive shaft (4) and vise versa. The extended motor pin (9A) of the motor (9) serves as an axle pin for the gear hub assembly (6A) The steady pin (10A) in the center of the shaver head (10) acts as an axle pin for the end of the drive shaft (4) that embodies the cam (4A). The drive shaft (4) as part of its structure, has a ring (4B) all around, and protruding out from it that allows the lever (7) to move it against the pressure of the spring (5) thus disengaging the cam (4A) from the bearing (1). The retainer (11) that holds the cutters and foils in place has an opening in its center to accommodate the bearing (1) and is snapped into place in the shaver head (10) and secured there by the clips (12) When the shaver is switched on the motor (9) sets the gear assembly (9B) in motion and assuming the cam (4A) is engaged in the bearing (1) the rotating drive shaft (4) together with its cam (4A) causes the bearing (1) to move in a circular motion carrying with it the arms (2) that are connected to the foils (3) and causing the foils (3) to move clock-wise and counter-clock wise in a oscillating fashion. The cam (1) is preferably offset from center on the drive shaft (4) approximately 0.5 mm.

As the three foils are oscillating one will be turning clockwise and two will be turning counter clockwise, this sequence changes continually with each foil in succession as the bearing with the attached arms to the foils moves in its circular motion.

This is ideal, as it raises the beard for a closer, smoother, and faster shave. For cleaning purposes the shaver head can be removed in the conventional fashion. When re-installing the shaver head, the steady pin (10A) will comfortably enter the countersunk end of the cam (4A)

What I claim is:

1. The combination with a triple head electric shaver including:
(1) A bearing mounted in the shaver head and attached to the cutter foils.
(2) A drive shaft with an offset cam that engages the bearing in the shaver head
(3) A drive shaft that rotates slower than the shafts that rotate the cutters.
(4) A drive shaft whose offset cam operating on a bearing attached to the cutter foils in the shaver head causes the bearing to rotate in a circular motion.
(5) A bearing with attachments to the cutter foils, when rotating in the shaver head causes the cutter foils to oscillate in the shaver head.
(6) A combination with a triple head electric shaver including means for oscillating the foils in the shaver head.
(7) A combination with a triple head electric shaver including means for engaging and disengaging oscillating foils in the shaver head.
(8) A combination with a triple head electric shaver including means for oscillating foils in the shaver head, to oscillate the foils at a slower rate than the rotating speed of the cutters.
